(19) United States
(12) Patent Application Publication
(10) Pub. No.: US 2007/0264566 A1
(43) Pub. Date: Nov. 15, 2007

(54) Electrode Arrangement Having Variable Geometry for Electrochemical Treatments

(76) Inventors: Axel Arndt, Berlin (DE); Ursus Kruger, Berlin (DE); Gabriele Winkler, Berlin (DE)

Correspondence Address: SIEMENS CORPORATION;INTELLECTUAL PROPERTY DEPARTMENT, 170 WOOD AVENUE SOUTH, ISELIN, NJ, 08830, US

(21) Appl. No.: 11/662,239

(22) PCT Filed: Aug. 16, 2005
(86) PCT No.: PCT/EP05/54032

§ 371 Date: Mar. 8, 2007

(30) Foreign Application Priority Data
Sep. 9, 2004 (DE) 10 2004 044 676.8

(51) Int. Cl. H01M 10/16

(52) U.S. Cl. 429/208

(57) ABSTRACT

The invention relates to an electrode arrangement having a variable geometry which can be adapted to a component which is to be treated. The treatment of the component can be an electrochemical coating or a removal of said electrochemical coating. According to the invention, said electrode arrangement comprises rod-shaped electrodes which are mounted in an axially displaceable manner in the base bode. As a result, they can be adapted to the profile of the surface, and the base body comprises a cavity which is filled with hard wax. Said cavity enables the rod-shaped electrodes to be axially displaced when the hard wax is liquefied and the rod-shaped electrodes to be fixed after the hard wax has solidified. Said electrode arrangement can be used in an advantageous manner in order to carry out the electrochemical treatment having a homogenous current density distribution on the surface.

### CROSS REFERENCE TO RELATED APPLICATIONS

This application is the US National Stage of International Application No. PCT/EP2005/054032, filed Aug. 16, 2005 and claims the benefit thereof. The International Application claims the benefits of German application No. 10 2004 044 676.8 filed Sep. 9, 2004, both of the applications are incorporated by reference herein in their entirety.

### FIELD OF INVENTION

The invention relates to an electrode arrangement having a variable geometry for matching to a component requiring to be electrochemically treated.

### BACKGROUND OF THE INVENTION

An electrode arrangement of said type is offered by, for example, the company Graphische Technik & Handel Heimann GmbH, Hamm (www.heimann-hamm.de). Said company's curved shaping electrodes are suitable in particular for electrochemically coating cylinders as components requiring to be electro-chemically treated, with the electrode grids being able to be bent over the cylinder's surface and arranged at a constant distance there from. That allows a relatively short distance of 4 to 6 cm to be set between the electrode and cylinder, with the anode grid allowing rinsing around the electrolyte. The even distribution of current on the surface requiring to be coated results in the deposition of very regular layers. The grid electrodes are offered in a variety of dimensions to enable matching to cylinder shapes having different heights and diameters.

Different electrode arrangements can be inferred from DE 101 32 408 A1, from WO 97/36708 A, from GB 1 037 334 A and the abstracts from JP 03-285097 A, JP 06-055363 A as well as JP 08-229742 A, said electrode arrangements being able to be matched to the surface of the work piece requiring to be electrochemically treated. For this purpose, the electrode arrangements comprise electrode elements mounted moveable axially in base bodies. The axial movement of these electrode elements allows the distance of same from the surface requiring to be electrochemically treated to be changed. A matching to the respective work piece is herewith possible.

### SUMMARY OF INVENTION

The object of the invention is to disclose an electrode arrangement for electro-chemical surface treatment, which arrangement can be used comparatively flexibly for different surface geometries.

Said object is inventively achieved through the electrode arrangement's consisting of stick electrodes mounted moveable axially in receptacles in a base body, with said receptacles having arresting means for the stick electrodes. The stick electrodes' being mounted moveable axially allows the electrode arrangement to be advantageously matched within an adjustment range to any surface profiles, with the stick electrodes being, after matching, arrested in the base body in such a way that the tips of the electrodes will be a constant distance from the surface requiring to be coated. If the distance between the stick electrodes is sufficiently small, then it will be possible while the surface is being electrochemically treated to advantageously achieve an even distribution of the current density resulting from the process. The field lines of the electric field generated between the tips of the stick electrodes and the surface will in each case be concentrated at the tips and be evenly distributed over the surface requiring to be treated in the electrode arrangement's area of influence.

The electrode distance can be adjusted advantageously in a simple manner prior to commencement of the electrochemical treatment process by bringing the electrode arrangement close to the surface requiring to be treated with the tips of the stick electrodes foremost so that these will move axially when their tips make contact with the surface. The setting range within which the surface can have any profile is determined by the length of the stick electrodes and possible stops in the receptacles. Only when all the tips are touching the surface will the stick electrodes be arrested in the base body so that this can be removed from the surface with the required distance between the tips of the stick electrodes and the surface being set. Instead of a separate arresting operation's being provided, axial guiding of the stick electrodes can also be embodied in such a way that a certain mechanical resistance will have to be overcome for moving the stick electrodes. When the electrode arrangement is removed from the surface requiring to be treated, the stick electrodes will then retain the position assumed when the resistance to movement was being overcome while the electrode arrangement was being brought close to the surface.

The treatment of the surface can consist of any electrochemical processes in which electrodes are used. The electrode arrangement therein forms the counter-electrode and the surface requiring to be treated forms the working electrode. Reference electrodes for controlling the potential of the electrochemical process can additionally be present that are either arranged separately or likewise form special stick electrodes of the electrode arrangement. Possible electrochemical treatment processes are, for instance, electrochemical de-coating or, as the case may be, coating of the surface requiring to be treated and electrochemical cleaning and polishing of the surface.

According to an advantageous embodiment of the invention it is provided for the base body to be plate type, with the receptacles being formed by the walls of holes in the plate. Said holes thus serve for inserting the stick electrodes so that guiding will be provided by the holes' walls. The holes can in particular traverse the plate as continuous holes, the result of which will advantageously be particularly reliable guiding. A plate-type base body advantageously requires little structural space.

According to a particular embodiment of the electrode arrangement the base body is embodied having a flat area in which the holes are located. From the free electrode length referred to the flat area, that will give a clearly defined setting range within which the geometry of the profile of the component requiring to be coated can be located. An electrode arrangement of said type advantageously has a particularly wide potential application range.

According to an alternative embodiment of the electrode arrangement it is provided for the base body to have a reference area in which the holes are located and which in its profile is substantially matched to a group of components requiring to be treated that exhibit similar geometry. Matching of the reference area to the geometry of the components intended for coating and understood as constituting a group within the meaning of the invention will allow, as it were, the electrode arrangement already to be given a basic setting with reference to the components requiring to be treated. That will advantageously enable optimal use to be made of the setting range enabling components exhibiting similar geometry (which is to say having similar dimensions and similar curvature radii) to be coated. Component tolerances can furthermore be compensated by appropriately moving the stick electrodes.

Turbine buckets, for instance, can advantageously be coated and de-coated using the electrode arrangement having a suitably matched reference area. These have a complex geometry which, in the case of same-sized turbine buckets, is sufficiently similar for said similarities to be capable of being readily equalized by moving the stick electrodes axially. That means that a multiplicity of turbine buckets used can be electrochemically treated by means of the inventive electrode arrangement so that time-consuming matching of, for example, grid electrodes to the different bucket profiles can be omitted.

For already described matching of the electrode arrangement with the base body being moved in parallel in a direction perpendicular to the surface, it is especially advantageous for the stick electrodes to be mounted in the base body such that they run in parallel. A particularly low-force movement of the stick electrodes in the associated receptacles will consequently advantageously be possible while the base body is being moved in parallel.

Another possibility is for the stick electrodes to be arranged with respect to their mutual distance and/or mutual angular relationship in such a way that by setting the constant distance between the tips of the stick electrodes and the surface requiring to be treated in the case of a group of components exhibiting similar geometry the tips will attain a substantially constant mutual distance. What is meant thereby is that account is taken of the group of components requiring to be treated to the extent that it will be foreseeable in which area the tips of the stick electrodes will be located. It will then be advantageously possible to at least substantially maintain a constant distance between the stick electrodes in said area so that the electric field necessary for the chemical treatment can advantageously be embodied having a nearly constant field strength.

According to a particular embodiment of the invention it is provided for the base body to have a cavity which the stick electrodes traverse and is filled with a solidifiable liquid, in particular a wax, forming the arresting means. Said liquid is liquefied for setting the stick electrodes so that they can be moved axially with little mechanical resistance. Once the stick electrodes' position necessary for coating has been found, the solidifiable liquid will be solidified so that the stick electrodes will be fixed in position. In the area of the cavity they can have a geometry precluding motion within the solidified liquid. Said geometry can be insured by means of, for example, plate-type offsets on the stick electrodes or by means of annular grooves. The plate-type projections can at the same time serve to limit the stick electrodes' axial play in the cavity if the holes through which they are guided are embodied as being smaller in diameter than the plate-type offsets.

The arresting means can advantageously also be formed by means of a clamping mechanism that engages with all the stick electrodes. Said clamping mechanism can, as already mentioned, either generally increase the stick electrodes' resistance to movement so that their position can be adjusted only by overcoming a resistance but that, owing to said resistance, they will retain their position after this has been adjusted when the electrode arrangement is lifted from the surface. Another possibility is for the clamping mechanism to be capable of being closed and opened so that the stick electrodes can be adjusted in their position with little force being applied but still be arrested in the position found when the clamping mechanism has been closed.

A development of the invention provides for the tips of the stick electrodes to have bridges made of an electrode material. What is meant thereby is that the bridges will also act like an electrode as they consist of an electrode material and are linked conductively to the stick electrodes. Said bridges will allow the electric field for the electrochemical treatment to be influenced locally in the area of the bridges. Influencing of said type can be used, for example, for locally producing an electric field stronger than that averagely set. Another possibility is to selectively compensate inhomogeneities in the field due to an insufficiently matched geometry of the electrode arrangement. Finally, the bridges can also be spread across the totality of stick electrodes (in the form of, for example, a pliable electrode grid) to overall increase the strength of the field formed by the stick electrodes.

It can furthermore be advantageously provided for part of the stick electrodes to be embodied as reference electrodes in the case of which an axial movement is possible independently of the arresting means. The additional axial movement will advantageously enable the reference electrodes to be positioned at a distance different from that of the other stick electrodes in relation to the surface requiring to be treated. For the reference electrodes to be used effectively, their distance from the surface requiring to be treated usually has to be less than that of the stick electrodes used as a counter-electrode. That can be achieved by, for example, fixing the reference electrodes in their additional axial movement, before the electrode distance is set, in a direction away from the surface by means of a geometry defined by means of a spacer. Spacers of said type can be removed once the electrode arrangement has been set in the manner already mentioned, as a result of which the reference electrodes can be moved closer to the surface requiring to be treated by the extent predefined by the spacer.

### BRIEF DESCRIPTION OF THE DRAWINGS

Further specifics of the invention will be described with the aid of the drawing, wherein the same reference numerals/letters have respectively been assigned to the same or corresponding elements thereof that will be explained more than once only insofar as there are differences between them in the individual figures.

FIG. 1 is a schematic of a section through an exemplary embodiment of the inventive electrode arrangement illustrating, on the one hand, a status during setting of the electrode arrangement (1a) and, on the other, a status during the electrochemical treatment (1b), and

FIG. 2 shows a further exemplary embodiment of the inventive electrode arrangement for coating a turbine bucket.

### DETAILED DESCRIPTION OF INVENTION

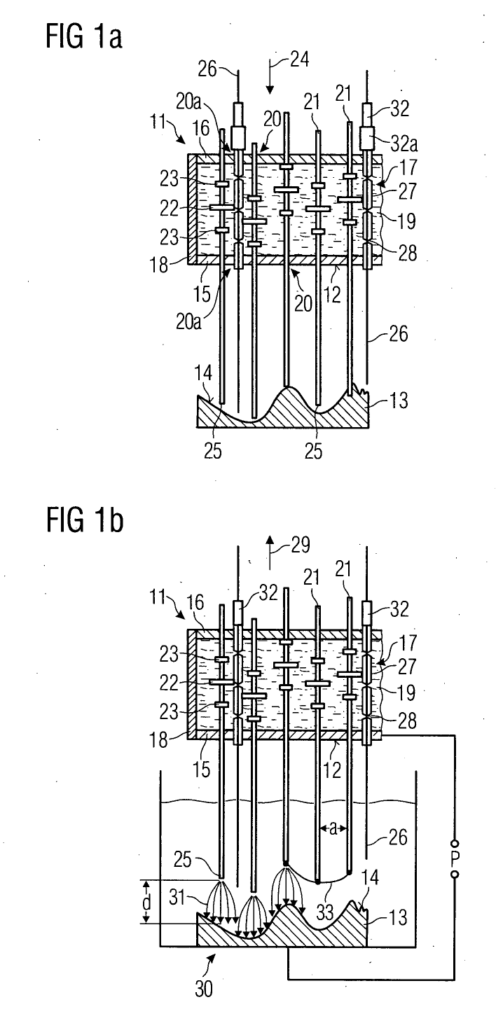

An electrode arrangement according to FIG. 1a has a base body 11 that is embodied as being plate-shaped and so has a flat area 12. Said area 12 is, when the electrode arrangement is being used, facing a component 13 having a surface 14 requiring, for example, to be coated. The base body has a base plate 15 forming the area 12 and a cover plate 16, with said plates 15, 16 enclosing a cavity 17. On the side edges of the base plate 15 and cover plate 16 is a connecting wall 18 by which the cavity 17 is completely sealed off from its surroundings. The cavity is filled with a hardenable liquid, for example hard wax 19.

Provided in the base plate 15 and cover plate 16 are holes 20 serving to axially guide stick electrodes 21. Said stick electrodes completely traverse the cavity 17 between respectively opposite holes 20 in the base plate 15 and cover plate 16 so that the stick electrodes can be translationally moved with a degree of freedom only along their axial extent. Within the cavity the stick electrodes have an arresting plate 22 and stop plates 23, with said plates 22, 23 forming offsets extending outward from the stick electrode. What is insured thereby is that the stick electrodes can be moved only axially when the hard wax has been liquefied. On having hardened through cooling, the hard wax will enclose in particular the arresting plate 22 having the greatest diameter, but also the stop plates 23 so that the stick electrodes will have been arrested in a certain position. The stop plates 23 additionally define the axial play of the stick electrodes as these in each case impact against the base plate 15 or cover plate 16 in the end positions of the stick electrodes' path of movement.

It is shown in FIG. 1 how the profile of the surface 14 of the component 13 can be mapped by the stick electrodes' tips 25 through lowering of the electrode arrangement in the direction of the arrow 24. The hard wax will have been liquefied during this operation and will be cooled until solidified when all the stick electrodes are touching the surface 14.

Contact between reference electrodes 26 embodied likewise as being stick-shaped and the surface will also be established when that is done, with said reference electrodes being guided in casings 27 in turn guided moveable axially in holes 20a in keeping with the stick electrodes. Said casings have annular constrictions 28 that arrest the casings 19 in the cavity 17 when the hard wax has solidified. Constrictions of said type in the form of annular groves can (not shown) be provided instead of the arresting plate 22 also in the stick electrodes 21.

It is shown in FIG. 1b how the electrode arrangement having the arrested stick electrodes 21 is lifted a defined extent in the direction of the arrow 29 with an axial distance d of the stick electrodes from the surface 14 of the component 13 being set. Said distance d has been suitably selected for producing an at least substantially constant distribution of current density on the surface 14 of the component 13 in a galvanic bath 30 with a potential P being applied to the electrode arrangement on the one hand (the base plate 15 serves to electrically contact the stick electrodes 21) and the component 13 on the other. The stick electrodes 21 are for that purpose in each case a constant distance a from the adjacent stick electrodes. The field lines of the electric field 31 forming between the tips 25 and the surface 14 are indicated by way of example to elucidate the constant distribution of current density on the surface 14. Said lines are concentrated at the tips 25 and distributed substantially evenly over the surface 14 owing to the distance d of the tips from the surface 14, and thus form a substantially homogeneous electric field for the treatment of the surface.

The tips of the reference electrodes 26 require a smaller distance from the surface 14 than the tips of the stick electrodes 21. Said reference electrodes can therefore be moved axially in the arrested casings 27, with the constrictions 28 at the same time providing a certain resistance to movement for the reference electrodes 26. To insure a defined reduction in distance between the reference electrodes 26 and the surface 14, spacers 32a which, according to FIG. 1b, are removed for the purpose of subsequently axially moving the reference electrodes 26, are provided at the stage shown in FIG. 1a between electrode mountings 32 of the reference electrodes 26 and the casings 27.

For locally influencing the electric field (not shown) a bridge 33 can also according to FIG. 1b be linked electrically conductively to the tips 25 of the stick electrodes 21. Said bridge can consist of, for example, a platinum wire or a grid. The electric link can be produced through soldering or by means of a conductive adhesive.

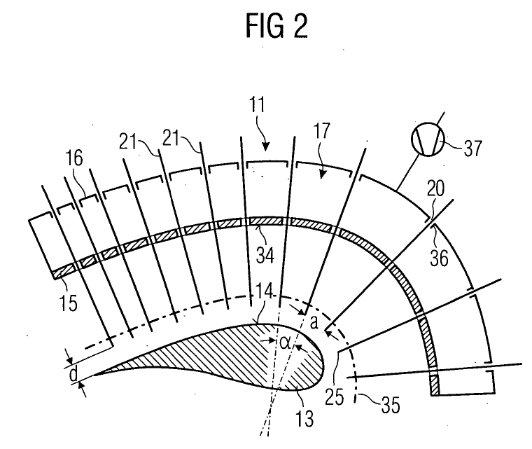

The component 13 is in FIG. 2 formed by a turbine bucket shown in profile. Said component's continuously curved surface is taken up by a reference area 34 of the base body 11 in such a way that the distance between the reference area 34 and the surface 14 will remain substantially constant. It will be advantageous to match the base body 11 to the component's surface contour if the maximum change in height in said contour exceeds the stick electrodes' axial adjustment range. The stick electrodes 21 can traverse the base body 11 in such a way as to stand substantially perpendicular on the surface 14 (see FIG. 2) or, particularly advantageously, to run in parallel in a flat, plate-type base body (see FIG. 1b).

The angle α describing the electrodes' mutual orientation is suitably varied to insure a constant distance a between the tips 25 in the vicinity of the surface 14. Said distance a between all the electrodes' tips is constant for the illustrated distance d and the illustrated profile of the component 13. The electrode device can, though, be used also for turbine buckets having similar profiles provided the profile curve is within a range indicated in FIG. 2 by, on the one hand, the surface 14 and by, on the other, the dot-and-dash line 32, which is to say that the tips 25 of the stick electrodes 21 can be within a range between 0 and 2 d, with the mutual distance a between the tips of the electrodes remaining substantially equal within said range.

The mutual distance between the parallel stick electrodes can in the case of a flat base body 11 (see FIG. 1b) alternatively (not shown) be varied. To achieve an equal distance between the tips of the electrodes 25, viewed parallel to the surface 14, the distance between the stick electrodes 21 must become smaller the more the surface 14 is inclined to the base body 11.

The arresting means for the stick electrodes 21 are in the case of the base body 11 formed by means of a clamping mechanism 36 consisting of elastic walls of the holes 20 in the cover plate 16. Said elastic walls will be applied against the stick electrodes 21 when a pressure is applied to the cavity 17 by means of a pump 37. The stick electrodes will be arrested thereby. The base plate 15 serves analogously to FIG. 2 to electrically contact the stick electrodes.

1-10. (canceled)

11. An electrode arrangement having a variable geometry for matching to a component to be electrochemically treated, comprising:
a base body;
a plurality of receptacles arranged in the base body, each receptacle having an arresting device;
a plurality of stick electrodes movably mounted in an axial direction via the receptacles and secured by the arresting device, wherein a portion of an individual stick electrode is a reference electrode having an additional axial movement independent of the arresting device.

12. The electrode arrangement as claimed in claim 11, wherein the additional axial movement of the reference electrodes is facilitated by casings that guide the reference electrodes and the casing are moveably mounted axially in the receptacles of the base body with the arresting device.

13. The electrode arrangement as claimed in claim 11, wherein the base body is plate-type, where the receptacles are formed by walls of holes in the plate.

14. The electrode arrangement as claimed in claim 13, wherein the base body has a flat portion where the holes are arranged.

15. The electrode arrangement as claimed in claim 13, wherein the holes are arranged in a reference area of the base body and a reference area profile is substantially matched to a group of components requiring to be treated that exhibit similar geometry.

16. The electrode arrangement as claimed in claim 15, wherein the stick electrodes are oriented parallel to the base body.

17. The electrode arrangement as claimed in claim 11, wherein the stick electrodes are arranged in terms of a mutual distance or a mutual angular relationship such that by setting a constant distance between a tip of the stick electrodes and the surface requiring to be treated in the case of a group of components exhibiting similar geometry the tips will attain a substantially constant mutual distance.

18. The electrode arrangement as claimed in claim 11, wherein the stick electrodes are arranged in terms of a mutual distance and a mutual angular relationship such that by setting a constant distance between a tip of the stick electrodes and the surface requiring to be treated in the case of a group of components exhibiting similar geometry the tips will attain a substantially constant mutual distance.

19. The electrode arrangement as claimed in claim 11, wherein the base body has a cavity which the stick electrodes traverse and is filled with a hardenable liquid, forming the arresting device.

20. The electrode arrangement as claimed in claim 19, wherein the hardenable liquid is a wax.

21. The electrode arrangement as claimed in claim 11, wherein the arresting device is formed by a clamping mechanism that engages the plurality of stick electrodes.

22. The electrode arrangement as claimed in claim 17, wherein the tips of the stick electrodes have a bridge made of an electrode material.
